(19) United States
(12) Patent Application Publication
(10) Pub. No.: US 2007/0227456 A1
(43) Pub. Date: Oct. 4, 2007

(54) Refrigerated pet feeding dish

(76) Inventor: Carl Norman Borey, Las Vegas, NV (US)

Correspondence Address: Carl Borey, 2385 East Windmill Lane, #308, Las Vegas, NV, 89123, US

(21) Appl. No.: 11/390,598

(22) Filed: Mar. 28, 2006

(51) Int. Cl. A01K 5/01

(52) U.S. Cl. 119/61.52

(57) ABSTRACT

A refrigerated pet feeding assembly with a removable thermally conductive dish designed to contain food, water or both that is continuously cooled by a thermoelectric Peltier-effect conditioning source and powered by an external dc voltage source such as a wall mount power supply or battery. The invention will maintain the contents of the feeding dish at cool refrigerated temperatures slowing the growth of bacteria.

### BACKGROUND OF THE INVENTION

This invention relates to the temperature control of animal watering and or food-feeding dish, in particular, to an improved cooling method for continuous temperature control of said feeding dish. This invention describes a removable thermally conductive dish that is continuously cooled by a thermoelectric Peltier-effect conditioning source within the base unit and requiring an external dc power source in order to maintain the contents of the removable dish at cool refrigerated temperatures. Pet owners frequently complain about the need for constant changing of pet water left out at room temperatures due to a bacteria build-up of slime. Keeping food and water at cooler temperatures slows the growth of the bacteria that can be harmful to household pets. Additionally, pet owners in warmer climates combat this problem quite frequently; especially with pet water left outdoors in the heat. Pets will often demonstrate a preference for cold water by drinking quickly from a recently filled water dish and clinical test have shown that cooler water helps lower their overall body temperature. So there is clearly a need for a refrigerated pet-feeding dish to thermally control food and water temperature at all times.

### DESCRIPTION OF PRIOR ART

Known prior art in cooled pet dishes includes U.S. Pat. Nos. 6,230,653; 4,691,664; 4,899,693; 5,738,038; 6,647,741: and 4,798,173. While these devices fulfill their respective objectives and requirements, the aforementioned patents do not disclose an electric refrigerated feeding dish. Additionally the inventive device has the capability to continuously control the temperature of the pet food and water without the need for removable inserts, gels, other freezable coolants or cartridges that require regular daily maintenance as described in the prior art.

### SUMMARY OF THE INVENTION

The primary object of the invention is to provide an improved means to cool domestic animal food and water by means of a refrigerated pet feeding dish that can thermally control food and water temperature at all times. Other advantages of the present invention will become apparent from the following descriptions, taken in connection with the accompanying drawings, wherein, by way of illustration and example, an embodiment of the present invention is disclosed.

The present invention is comprised of a removable thermally conductive pet dish designed to contain food, water or both. The invention allows pet food and water to be left out and available at all times while keeping the food cold to reduce spoilage. The present invention contains at least one Peltier effect thermoelectric element connected to an external dc voltage supply, whereby the removable pet feeding dish is maintained at cool refrigerated temperatures by means of direct contact with the Peltier plate assembly.

### BRIEF DESCRIPTION OF THE DRAWING

FIG. 1 is an illustration of a new refrigerated pet feeding dish according to the present invention

[FIG. 2 is a cross sectional view thereof.

FIG. 3 is an exploded cross sectional view of the present invention.

### DETAILED DESCRIPTION OF THE PREFERRED EMBODIMENTS

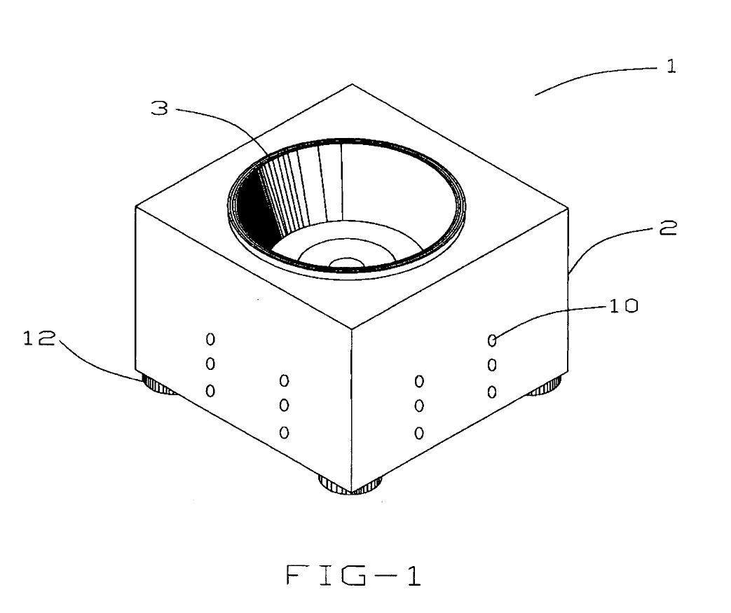

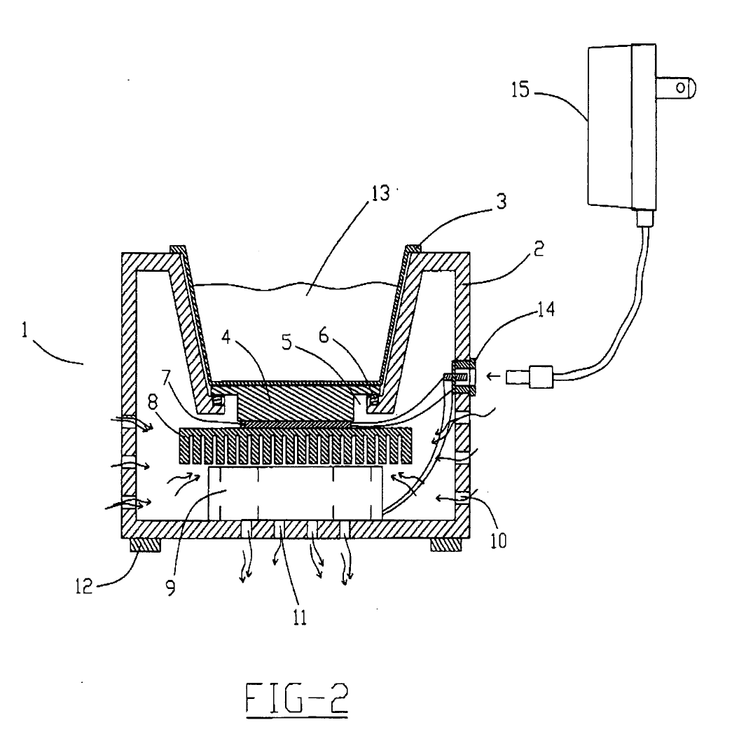

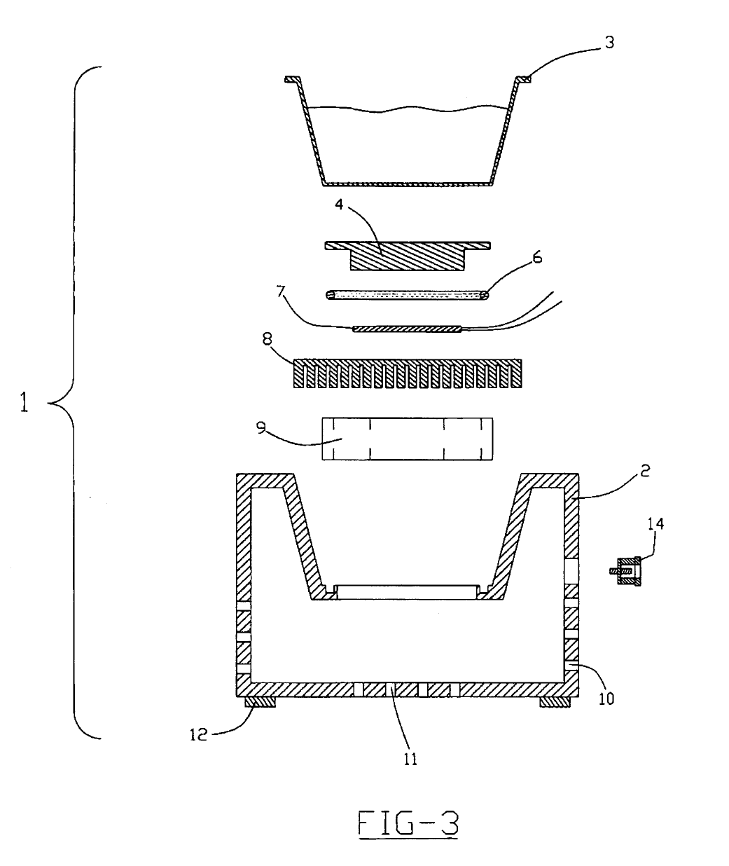

Detailed descriptions of the preferred embodiment are provided herein. Referring now to FIG. 1 we see the illustrated embodiment of a new refrigerated pet-feeding dish according to the present invention. Referring now to FIG. 2, a cross sectional view 1 is taken centrally through the refrigerated pet-feeding dish. The thermoelectric base unit housing 2 incorporates a cavity that houses a removable thermally conductive dish 3 that when in contact with the thermally conductive plate 4 is cooled by a joined Peltier effect thermoelectric element 7. The Peltier element's lower hot plate on the opposite bottom side is bonded to a metallic heat sink 8 with the fins of the heat sink extending downwardly and are cooled by an axial cooling fan 9. Ambient air enters through vent holes 10 in the housing and is drawn through the cooling fins on the heat sink 8 and is pulled through the axial fan 9 and expelled out the exhaust vent holes 11 in the bottom of the housing. The housing is raised with non-skid feet 12 that allow the air to exhaust out of the bottom of the base unit. The housing has an opening 5 in which the cooling plate 4 drops into and is sealed by an o-ring 6 which will prevent water or food 13 from entering the housing and possibly damaging the Peltier device 7. The Peltier device 7 as well as the axial fan 9 is typically powered by an external DC power supply 15 that would be connected to the refrigerated pet dish assembly 1, through the electrical connector 14. Referring now to FIG. 3, FIG. 3 is an exploded cross sectional view of FIG. 2 therein, provided for an improved understanding of the various components.

While the present invention has been described in connection with a preferred embodiment, it is not intended to cover such various changes in shape, size and arrangement of parts without departing from the scope of the invention. Accordingly, the invention should not be limited by the described embodiments but rather interpreted in accordance with the appended claims.

What is claimed is:

1. A refrigerated pet-feeding dish assembly comprising: a) an electrically powered Peltier-effect cooling unit with a cavity for housing a removable dish. b) A removable thermally conductive dish designed to contain pet food or water. c) A DC voltage source.

2. The refrigerated pet-feeding dish as recited in claim 1 where the dc voltage source is an external dc power supply.

3. The refrigerated pet-feeding dish as recited in claim 1 where the dc voltage source is a battery.

4. The refrigerated pet-feeding dish as recited in claim 1 with a polarity-reversing switch to reverse the polarity of the DC supply voltage.

5. The refrigerated pet-feeding dish as recited in claim 1 with the addition of a water-circulating pump.

6. The refrigerated pet-feeding dish as recited in claim 1 with an electrical thermostat switch to control the dish temperature.

7. The refrigerated pet-feeding dish as recited in claim 1 wherein the thermally conductive bowl is coated with a material, with antimicrobial properties.

8. A refrigerated pet-feeding dish assembly comprising: a) an electrically powered Peltier-effect cooling unit with a cavity for housing a non-removable dish. b) A non-removable thermally conductive dish designed to contain pet food or water. c) A DC voltage source.

9. A refrigerated pet-feeding dish assembly comprising: a) an electrically powered Peltier-effect cooling unit with a cavity for housing a removable dish. b) A removable thermally conductive dish designed to contain pet food or water. c) A DC voltage source. d) Holes or other mounting means on one or more sides of the assembly, to mount the unit to a wall or wire cage in a hanging fashion.
